(19) United States
(12) Patent Application Publication
(10) Pub. No.: US 2008/0281616 A1
(43) Pub. Date: Nov. 13, 2008

(54) Innovation system

(76) Inventor: Cameron Johnson, Loma Linda, CA (US)

Correspondence Address: WESLEY B. AMES, 7031 LOS VIENTOS SERENOS, ESCONDIDO, CA, 92029, US

(21) Appl. No.: 12/072,915

(22) Filed: Feb. 27, 2008

Related U.S. Application Data
(60) Provisional application No. 60/891,890, filed on Feb. 27, 2007.

(51) Int. Cl. G06Q 10/00

(52) U.S. Cl. 705/1

(57) ABSTRACT

A method and system for encouraging innovation is described that includes conducting innovation contests and ranking innovators. The process allows high-level innovators to be identified, thereby improving the efficiency of finding innovative solutions and/or innovative employees.

### RELATED APPLICATIONS

This application claims the benefit of Johnson, U.S. Provisional Appl. 60/891,890, filed Feb. 27, 2007, entitled Innovation System, which is incorporated herein by reference in its entirety.

### FIELD OF THE INVENTION

The present invention relates to a system for fostering innovation in a variety of different fields.

### BACKGROUND OF THE INVENTION

The following discussion is provided solely to assist the understanding of the reader, and does not constitute an admission that any of the information discussed or references cited constitute prior art to the present invention.

A few companies have begun to solicit ideas using contests, with rewards to the winner of the contests. Innocentive, Idea Crossing, and Top Coder provides examples of this approach.

Innocentive developed as a spin-off from Eli Lilly, and conducts web-based contests on challenges posted by companies seeking solutions. The companies pay fees for access to the system. The reward for the winner is posted, and the seeking company selects the winning entry.

Idea Crossing develops and conducts contests for ideas and solutions to posted challenges. For example, a company may wish to conduct a contest for its employees; Idea Crossing can develop and conduct such a contest.

Top Coder presents contests for coding (computer programming) solutions.

A related approach is provided by Guru.com, which provides a matching service between entities seeking services of various kinds, and experts able to provide such services.

### SUMMARY OF THE INVENTION

The present invention is directed to a system for fostering innovation through innovation contests or challenges, with associated ranking of innovators and/or participating solicitors (e.g., companies seeking innovative solutions). This system provides greater efficiency in a number of different areas associated with innovation, including, for example, more rapid and efficient development of solutions to problems, more efficient hiring of innovators, and more efficient outsourcing, among others.

Thus, a first aspect of the invention concerns a method for fostering innovation by conducting a plurality of web-based solutions contests through a web site, on a corresponding plurality of problems presented by innovation seekers, i.e., solicitors. A plurality of innovators, e.g., at least 10, 20, 40, 60, 100, 200, 400, 600, 1000, 2000, 5000, or 10000, or even more, submit proposed solutions to the problems. In each contest, innovators are ranked or scored based on innovativeness; such a score or ranking may represent a plurality of parameters. Such a plurality of parameters may be chosen as desired to represent innovativeness in a particular context and/or additional scores may be determined and used, e.g., a parameter(s) and/or score(s) representing productivity. If desired, innovativeness and productivity may be combined in a single score. In most cases, for each contest a winner is selected who receives a winner's prize. In some cases, however, a winner is not determined, but the solicitor arranges with one or more of the solution-submitting innovators for further solution development, e.g., as a collaborative group. In the latter cases, each of the selected solution-submitting innovators may receive an incentive award and/or the participants in further development may receive a winner's prize or other award if the further developed solution is accepted by the solicitor.

In particular embodiments, a plurality of the contests are pre-specified time contests; a plurality of the contests are open-ended contests; the innovators register on the web site with identifying information and temperament information, and optionally field of expertise information; the innovators are registered on the site and an innovation score is part of a resume for each registered innovator; a plurality of innovators are selected who participate in a second round of innovation on the problem in a collective collaboration; the method also includes determining a temperament or a plurality of innovators, e.g., for each registered innovator; temperament determination is used to identify intuitive perceiver (N-P) individuals; N-P individuals are identified and invited to join the system; N-P individuals are identified and at least some problems are presented to a selection of such N-P individuals; solicitors pay a fee for presenting a problem or problems on the web site.

In a related aspect, the invention concerns a system for fostering innovation, which includes a computer accessible web-based system that includes an innovation contest presentation portion, and an innovation contest reward portion. In most cases, the system also includes a portion for determining and recording innovation scores for innovators.

In particular embodiments, the system is configured for carrying out the method of the preceding aspect, e.g., is configured to carry out the described functions.

In a further related aspect, the invention provides a method for identifying and/or providing a pool of innovator entities, where the method involves presenting a plurality of innovation contests on a web-based system presenting a plurality of problems to a plurality of registered potential innovators, and ranking or rating the plurality of innovator entities based on parameters of innovativeness and/or productivity. Cooperation may also be included as a parameter. Such parameters may be weighted as desired to the particular context. The rankings or ratings may be represented as a score, e.g., an innovation score. The method can also include identifying and selecting (or weighting) N-P individuals from those potential innovators. Advantageously, the ranking or rating for an innovator (e.g., an individual or group of individuals) may be cumulative over a plurality of contests, e.g., at least 2, 3, 5, 7, 10, 20, or more contests.

In particular embodiments, a cut-off of cumulative innovation scores is used to create a pool of high performing innovators; innovators with N-P temperaments are separately identified.

In yet another related aspect, the invention concerns a pool (which may be a ranked pool) of innovators, where the pool includes a list embedded in computer memory (e.g., in server and/or database memory) of innovators who have participated in a plurality of innovation contests on a web site, where the innovators have a cumulative innovation score for the plurality of contests. For a ranked pool, the innovators are ranked according to their innovativeness scores.

In particular embodiments, the list includes information as described for the preceding aspect.

A further aspect involves a method for sharing rewards in a contest-based innovation system (e.g., as described for an aspect above or otherwise described herein) by conducting a market for interests in innovation rewards by innovator entities.

In particular embodiments, the interests are permanent interests; the interests are limited time or limited contest number interests or specified contest interests.

Likewise, in particular embodiments, the market is conducted for innovators with an innovation score over a pre-selected threshold; the innovation system receives a portion of the consideration (e.g., money) paid for the interests.

Reference to “web-based” currently refers to the world wide web, or more generally the Internet. However, it also includes any other similar public network which provides generally available network connectivity.

Additional embodiments will be apparent from the Detailed Description and from the claims.

### BRIEF DESCRIPTION OF THE DRAWINGS

FIG. 1 shows an illustrative example of an innovation contest listing page.

FIG. 2 shows an illustrative example of a particular contest summary page.

FIG. 3 shows an illustrative example of an idea submission page.

FIG. 4 shows an illustrative example of an innovator dashboard page.

FIG. 5 shows an illustrative example of a contest detail page.

FIG. 6 shows an illustrative example of an idea submission page with an option for public or private submission.

FIG. 7 shows an illustrative example of an innovator idea evaluation page.

FIG. 8 shows an illustrative example of a solicitor listing page.

FIG. 9 shows an illustrative example of a solicitor public profile page.

FIG. 10 shows an illustrative example of an idea bid offer page.

FIG. 11 shows an illustrative example of a solicitor's dashboard page.

FIG. 12 shows an illustrative example of a solicitor contest posting page.

FIG. 13 and FIG. 14 together show an illustrative example of a solicitor's contest detail page.

FIG. 15 shows an illustrative example of a winner and bid offer selection page.

FIG. 16 shows an illustrative example of a bid offer entry page.

### DETAILED DESCRIPTION OF THE PREFERRED EMBODIMENTS

The present invention concerns a method and system for developing and/or utilizing innovation, and is applicable to many different fields. While the approach utilizes innovation contest, it also involves a number of additional components which extend the benefits dramatically. In its simplest form, the method involves solicitors (e.g., companies) seeking innovations (e.g., ideas or solutions to problems) and/or innovators. The field may be any in which ideas and/or solutions are needed. These can include, but are not limited to advertising, marketing, engineering, biology, mathematical theorems and proofs, process and system innovation, names and/or logos for businesses (e.g., new businesses) and/or products, jokes, comedy routines, and many others. In essence, the method and system can provide a marketplace of innovators, problems, and innovations which improves in efficiency over time and/or with increasing numbers of participants.

The method and system may be implemented in various ways. For example, the system may involve a web site focused on the innovators and solicitors. As a further example, such a web site may be implemented as a social networking site or have social networking components.

Thus, a system can be set up which provides a forum where solicitors present problems for solution by potential innovators, e.g., in the form of solution contests. As innovators participate in multiple such problem solutions, they build up an innovation score which reflects their innovativeness. Either as a separate score or as part of the innovation score, productivity and/or a cooperation rating can be included.

In a manner similar to an innovation score, solicitors (as well as innovators) can develop trust scores. Such trust scores reflect experience within the system. For example, solicitors which consistently and appropriately reward participating innovators will develop better trust scores than solicitors which more often do not select a winner or otherwise reward participants. Innovators may, for example, develop trust scores through consistent and beneficial interactions with solicitors and/or other innovators, e.g., in cooperative environments and/or in handling proprietary information.

Such scores or ratings of innovators provide additional capabilities. For example, the development of innovation scores allows solicitors to selectively present their problems only to a subset of innovators who are more likely to develop a useful solution, or to look initially or only at proposed solutions presented by individuals whose innovation scores at least satisfy a selected level.

In one example, a system named Big Nerve, referenced in the following description, illustrates how such a system can operate.

### I. Innovators

The present method and system are built on the participation of innovators. Such innovators may, for example, be single individuals, groups of individuals, groups of groups, or mixed groups of groups and individuals. Such groups may be local and/or may be geographically dispersed. The system is designed to locate and/or attract innovative individuals and to provide channeled outlet for their innovative capabilities.

In most embodiments, innovators register on the system, e.g., in a manner similar to registering with a temporary employment agency. They enter their basic identification in a manner similar to they would to apply for a job. The registration can also include questions adapted to ascertain their temperament traits.

Advantageously, the system can be set up to identify and focus on harnessing the capabilities of individuals who have an innovative temperament, although the system need not be restricted to those individuals. It appears likely that no more than 11-12 percent of the US population (unknown for the world population) has an innovative temperament. Such innovative temperament is currently correlated with the Intuitive Perceiver temperament determined in the Myers-Briggs test; a test which is frequently used by human resource departments of large companies. Of course, other such tests of temperament may be developed which identify individuals or categories of individuals who tend to be more innovative than other temperaments. Such tests may be used as alternatives or as additions to the Myers-Briggs test. As indicated, such identification does not mean that individuals having other temperaments should not or cannot register and compete in problems under the present system. Rather, the system can advantageously incorporate searching and recruiting individuals who have an innovative temperament, e.g., who are N-P's.

The search can include creating a culture that is conducive to them on a system web site and/or actively going to Internet and/or physical locations where such innovative temperament individuals tend to congregate. Using the designations of the Myers-Briggs test, the innovative temperaments currently identified are ENTP, INTP, ENFP, and INFP. These temperaments are described in numerous books, e.g., Please Understand Me and Psychological Types, among others, as well as in articles. Such individuals tend to perform well in functions involving forming inferences, giving them an advantage when solving problems in which intuitive leaps of innovation are advantageous. They also tend to understand each other well due to their brains functioning in similar ways. This allows them to collaborate well in many problem solving situations, e.g., when brainstorming problem solutions.

Innovators can participate in the system as individuals, or can participate in groups. Such groupings may be consistent, or may be formed for a limited time or for a limited selection of contests (e.g., for a particular contest). The system may be configured such that innovator groups can develop their own innovation scores.

The power of the present system to foster innovation will increase dramatically when large numbers of innovators participate consistently.

### II. Solicitors

On the other side of the innovation system from the innovators are the solicitors (which can also be referred to as solution seekers and by similar terms). Such solicitors will often be companies, but may also be individuals, government agencies, and the like. Essentially any such entity can submit problems on the system to elicit proposed solutions from potential innovators (generally after registration).

### III. Contest System and Benefits

A system such as Big Nerve is a conduit, facilitator, and nexus for a marketplace of innovation to develop. As indicated above, on one side are solicitors, e.g., companies, seeking for innovation. As examples, the innovation fields can range from, advertising, marketing, engineering, biology, to mathematical theorems and proofs, to process and system innovation, to names for a new business to, jokes and comedy, etc.

On the other side of Big Nerve are the world's innovators who have registered on the site. They enter their basic identification as they would to apply for a job. They may advantageously be asked questions to ascertain their temperament traits.

Preferably, a system such as Big Nerve is set up, at least primarily, as a web-based system. In such a system, the registration of solicitors interested in submitting problems, the submission of problems, the registration of innovators, and the submission of proposed solutions are all preferably conducted online. The beneficial results from such a system can include the reduction of “noise” in the marketplace for innovation. This can be accomplished in several ways, which may be used alone or in combination.

As an example of generally how such a system can be structured, on a searchable bulletin board are questions (e.g., contests) needing innovative solutions; usually with prize monies. The questions may be listed in various ways, e.g., categorized by field, date, and/or in other ways. For many contests, any innovator on the system (preferably from anywhere in the world) can select a contest to enter and send in a solution whether they have any training in that field or not. Even though innovation will most often come from experts in the particular field, innovation can also come from the crossover of two or more different or divergent fields, e.g., psychology and economics, or geology and mathematics, etc. Individual innovators can work alone or as identified teams with their own separate identities. It is expected that teams will be particularly useful for complex problems. Such teams may be formed for only a particular project or projects, or may be stable teams over numerous projects and may even have legal entity status outside the present system.

1. Innovator Pool Enrichment

In order to efficiently facilitate innovation, it is desirable to arrange for the participation of inherently innovative individuals. As indicated above, some types of individuals are more likely to innovate than others. Thus, by using demographic and temperament data we can encourage the participation of individuals who are more likely to be innovators, and/or can add some predictive values for any participant even before they enter a contest based on their likelihood of being good innovators, or even of the likelihood of their being good innovators on a particular problem or particular types of problems. This is similar to what an actuary does in insurance in assessing risk. An innovative temperament can be assessed using tests, e.g., the Myers-Briggs test or similar, and subsequent performance can be rated using scores and/or other rating based on rated performance.

While this does not mean that other individuals with other temperaments cannot or should not participate, there is benefit in encouraging such individuals (e.g., those classified as ENTP, INTP, ENFP, and INFP using the Myers-Briggs test) to participate, thereby enriching the potential innovator pool in the system for individuals more likely to be effective in coming up with innovative and valuable solutions. This can be accomplished in various ways, e.g., by creating a culture that is conducive to them on the system website and/or actively going to the virtual and/or physical places where they congregate. Gathering this particular community can increase the efficiency of the innovative process tremendously.

2. Contests and Contest Types

As mentioned above, the system can utilize innovation contests as a mechanism for promoting innovation. Under this mechanism, solicitors can submit questions or problems on the web site to which potential innovators can submit their proposed solutions. With these contests, solicitors draw on the community of innovators to elicit solution ideas. The solicitors may include restrictions or provisos on the contest. Contests may also be structured in various ways.

In one structure, the solicitor posts a problem and will select a winner from among the responding innovators. The contest always has a winner (assuming there are respondents) to whom the prize money or the winner's portion of the prize money is awarded after the contest interval (such as after a specified period of time). Such a contest may be referred to as a Type A contest. Preferably the rewards are distributed more deeply. For example, the winner or submitters for the top few solutions will each receive a portion of the prize (such as 40-80 percent of the total prize), but desirably, a portion of the total award is also distributed to other submitters, e.g., to encourage participation. Such distribution may, for example, be over the top 10, 20, 25, 30, 33⅓, 40, or 50 percent of entries. The distribution can even include all solution submitters, or all submitters whose submission receives a rating meeting a selected level.

Typically, initially submissions from innovators are viewable by the solicitor, but not by other innovators. Desirably, when a solicitor views submissions, each viewed submission must be evaluated and rated by the solicitor (e.g., on a scale of 1 to 10), preferably before proceeding to view the next submission. Also desirably, all submissions for a particular contest are rated by the corresponding solicitor. Additionally, the system can allow solicitors to provide feedback to submitters, which may, for example, assist a submitter to reach a useable solution. In cases, where an innovator submits one or more improved or refined submissions, the ratings may be assigned in a number of different ways, such as averaging over each of the entry versions, or using only the rating for the last entry version.

The system or a particular contest may be configured such that the solicitor must view and preferably rate all entries before selecting a winner or useable entry; such ratings include innovativeness and/or usability (which may be represented by a single rating or separate ratings). However, in some cases rating or even viewing of all submissions may not be required and may not be performed (e.g., viewing all submissions may not be practical). For example, a solicitor may choose to view only submissions by innovators with innovation scores better than a specified level, or may choose to view only a selected number of submissions, or may stop viewing submissions once an acceptable submission is found. In such cases, some innovators may have submitted solutions which were not evaluated by the solicitor.

Therefore, advantageously, the system can be configured such that evaluations of submissions are opened up to viewing by other innovators, e.g., all other innovators in the system or all other innovators who submitted proposed solutions for the particular contest. The other innovators can similarly rate the individual proposals (preferably excluding their own). These community ratings can produce a ranking of proposals. The open viewing of submissions may be automatic, or may require approval by the submitter, or may have other conditions. The open viewing and rating represents an “open contest.” The ratings from the solicitors and from the community can be retained and used separately, or may be merged in a combined rating. In many implementations, the community ratings will be given greater weight than the solicitor ratings. Following the community rankings, the entries (now ranked) can be submitted to the solicitor again, for example, so that the solicitor may consider purchase of additional ideas.

Use of submissions for a particular contest by the respective solicitor can be arranged in various ways. One option is that the solicitor has the right to use the winning entry. Such use may be without further compensation beyond the contest prize, or may be under other pre-specified conditions or under additional conditions negotiated between the submitting innovator and the solicitor. Additionally, a solicitor may also arrange for use of one or more other solution submissions, for example, following the open community ranking. Such use may be under agreed conditions. Such agreed conditions may, for example, be pre-specified or may be negotiated between the submitter and solicitor.

As one alternative type of contest, a contest may be conditional, such that the contest only has a winner when the solicitor receives a solution it deems usable or acceptable to itself. The period during which the contest runs can be open ended or specified (e.g., limited by time and/or by number of respondents). Such contests can be referred to as Type B contests. Awards under Type B contests in which a winner is accepted can be done in substantially the same way as indicated for Type A contests above, and can include solicitor and/or community ratings in substantially the same way.

A further variant under Type B contests involves branching into phases or conditional alternatives. For example, a contest may have a Phase 1 branch and a Phase 2 branch. In Phase 1—if no winner is chosen then the contest closes without any payment of prize monies. The solicitor can opt to run a Phase 2 trial in which they pick from one or more e.g., 2-1000, innovators which haven't given them the solution they are satisfied with yet but whose solutions up to that point have shown promise or their Nerve Scores are high or their process of thinking seems efficient and lucid, etc., and offer them an opportunity to participate further. Usually the solicitor would have the option to select as many or as few innovators as desired for the further participation, and the individual innovators would have the option of accepting or declining further participation. The solicitor can award a portion of the prize money at this stage and/or can “hire” the innovators for agreed fees. For example, each of the selected innovators may only receive a portion of the prize money if they agreed to work further on the problem.

Advantageously this further participation can involve working cooperatively with other innovators who were picked, for example, for a specified period of time. If at the end of the additional work period (e.g., cooperative work period) this innovator or forum of innovators comes up with a usable solution, an additional award may be made to the participants or winning participants (e.g., the rest of the prize money or the rest of a winner's portion of the prize money). Where the additional work was performed cooperatively, the additional award would be awarded to the team to be split up equally or apportioned as deemed suitable, e.g., according to their own intra-team rankings of each other. Of course, other solution submitters who were not involved in the collaborative forum can also receive awards, similar to the additional distributions described for Type A contests and for Type B contests in which winners were accepted.

Under a cooperative Phase 2, preferably each member of the team would be able to see each other's identification (and preferably full resume) and previous solutions for that particular contest. Advantageously, they could collaborate, debate, and/or brainstorm in a forum on the system web site. Preferably they would be able to use multiple mediums of communication if needed, e.g., written, voice, video conferencing, drawing, AutoCAD, face to face, etc.

The Phase 2 can be open or closed. If open the whole world (or the entire set of system participants) can see the ongoing innovative discussion and can feed solutions to members of the forum. Each member of the forum could, if they so choose, act as a portal sifting through solutions that are given to them from the world community. They then could bring the best solutions to the forum for evaluation and discussion. The forum members will have a strong incentive to work together to find a solution for the company in order to get the rest of the prize money. It can also be advantageous if the forum members are able to submit questions to the company on an ongoing basis during Phase 2 trials.

At the end, the members of the forum would submit their proposed solutions, e.g., arranging their best solutions from top to bottom to present to the solicitor. At the end they would also rank each other on the three Nerve scales-Innovativeness, Productivity, and Cooperation. If no solution is acceptable to the company by the end of the specified time, the rest of the prize money is not awarded. If the prize money is awarded it could be awarded equally to the members or weighted on their intra-forum rankings. These ranking in the any rate will be weighted in their ongoing cumulative Nerve Score and the forum participation will go on their system Resume.

In some cases, solicitors may wish to go outside the contest system. For example, this may be desirable where maintaining the confidentiality of the information to be provided by the solicitor has value. In such cases, a solicitor may contract with one or more innovators to work on a problem. Preferably a collaborative group is used, e.g., in a manner similar to that described above for Type 2 contests.

In the context of the mechanisms by which solicitors can seek innovation with the present system, three filters are apparent and can be used, especially the solicitors. The first is the use of innovator scores (e.g., Nerve Score), which rate innovators based on historical competencies. This type of rating is described further below. Usually this score(s) is used as an initial filter. Selecting innovators based on innovator scores assists in maintaining confidentiality, but is not fully robust in addressing particular problems or queries. The second is the use of the community rankings. This filter is more robust as it is based on actual solution submissions, but due to it at least partially open nature, confidentiality is reduced or even eliminated. The third filter is the collaborative forum. In this setting, some confidentiality can be retained, e.g., due to the selection of innovators for participation in the forum and to the limited numbers of participants in most cases. The collaborative forum is robust for addressing particular queries, and is well adapted for complex innovation problems.

Another avenue available for solicitors to benefit from the community of innovators is employee or contractor hiring by a solicitor from innovators in the system. For example, based at least in part on the nature or quality of a particular innovator's submission(s), and taking into account whatever additional considerations are important to the solicitor, a solicitor may wish to hire an innovator as an employee or as an independent contractor. In this context, the system functions similarly to a headhunter or employee placement agency.

For example, Company A in engineering might hire 100 engineers currently based on resumes and referrals. Of that group possibly 20% are of the N-P brain type, and it would be very difficult or impossible for the company to initially determine which individual or small number of individuals would be most suitable for a particular project. On the present system (e.g., Big Nerve) we would be able to sort through thousands of engineers most of whom are N-P's. Company A could pick the one out of that group that is right for their particular project, and can based that selection on that engineer's prior performance in innovation and even on innovation on the particular problem to be addressed. It would have otherwise meant hiring hundreds of thousands of engineers on their own to find that one innovative engineer that rose to the top. On the other hand, Company A might now want to hire that engineer but just outsource a particular project to him or her on a contract basis.

3. Innovator and Solicitor Ratings

The present system advantageously utilizes ratings, e.g., scores, for innovators and solicitors. These ratings or scores can be used to reflect one or more aspects of the innovation environment, such as innovativeness, productivity, and/or cooperation for innovators. For solicitors, such ratings or scores may, for example, represent trustworthiness and/or timeliness. The ratings or scorings involve evaluations. Useful evaluations can include one or more of: evaluations of innovators by solicitors, evaluation of innovators by other innovators, evaluation of companies by innovators, evaluation of evaluators by solicitors and/or innovators (e.g., based on the ability of the particular evaluator to reflect the judgment of the community or relevant portion thereof).

As indicated, based on proposed solutions submitted, innovator entities will be rated at least on the innovativeness of their respective proposed solutions. Preferably each innovator submitting a proposed solution will be rated. This rating can be on one or on several scales, with the ratings typically performed by the solicitors for the respective problems.

People can participate in contests alone or in teams. The team will also be given its own identity. If the company opens up the solution from an innovator or team of innovators, preferably they can't move on until they rate or rank that solution. The rating or ranking will be usually include innovativeness, and may also include productivity and cooperation scales. These can be used separately or can be weighted and given as a cumulative innovator score (e.g., Nerve Score) that follows the innovator or team of innovators similar to chess ranking. Their history of contests and amount of participation will also follow them in a Big Nerve Resume as they compete on the site.

As described above, innovator scores can result from solicitor ratings, but can alternatively or additionally include ratings from other members of the innovator community.

Solicitors can also be rated or ranked on the system by innovators, and thus can develop long-term identities built over time on reputation and thereby build trust. The innovators can rate or rank the companies, based, for example, on one or more of cooperation, trustworthiness, timeliness, how many ideas they have bought, in what percentage of contest do they award a prize, and/or whether there are any accusations of idea stealing. Their scores can be weighted and their reputation on the site can be tracked. Preferably, an innovator can quickly see a Reputation or Trust Scale on each company; in some implementations an innovator can read comments and complaints (if any) by previous innovators. In this way the system can function similar to a better business bureau, but with greater potential enforcement. For example, if there is a breach of contract by a company or innovator the system can discontinue their membership in or participation on the site. Those long term reputations or trust levels can be utilized in the system in additional ways, e.g., in the terms available to the company or solicitor for participation.

4. Problem Formulation

Asking the right question is at the core of solving any problem. Through the system solicitors can be assisted in asking testable questions and breaking down larger projects into good contests. This can be done in an informative way with the companies. Alternatively, contests can be run to organize contests. The system innovator community will help break down a project in the quickest and most efficient way. A community of project managers will consequently develop whose expertise can also be contested and tracked. It is expected that such contests to organize contests will develop after the system innovator community is well established.

5. System Transparency

Creating an environment of trusts is probably the most important step in increasing efficiency of innovation. Trust developed and tracked for solicitors is discussed above. In addition, it is useful to include steps or mechanisms to develop and maintain trust in the system (e.g., in the web site and its operators). This can be facilitated by making the process transparent. For example, the site can post how much money is obtained by the system, e.g., for contests and “bill of rights” that the innovators and solicitors agree to and which are observed by the system and by the innovators and solicitors. As trust in the system and its participants develops, both innovators and solicitors will be motivated and encouraged to participate.

### IV. Innovation Markets

The present system can also include a “stock market of ideas” and/or a “stock market of innovators.”

1. Stock Market of Ideas

Such a stock market of ideas pushes the innovation process from the innovator to the companies, as distinguished from innovations being pulled from innovators to companies through the contests as described above. For a stock market of ideas, companies can benefit from assistance in identifying ideas that are more likely than others to be valuable. This can be done in at least two ways. The first is by using innovator scores (e.g., Nerve Scores) to identify innovators who are more likely to present effective or valuable innovation ideas; the second is by using community ranking and therefore involves the wisdom of crowds.

To illustrate, we can consider ACME Greeting Card Co. which opens a stock market module on the system. Any innovator (or any innovator who satisfies a particular innovator score) can post ideas in that module, and it is preferably listed according to the innovator's innovator score. The list of ideas is closed to other innovators but open to the company (e.g., the ideas are posted in a closed bin in the module). The company can review the ideas and purchase any they wish under terms agreed with the submitting innovator (e.g., negotiated at the time or agreed in advance).

Alternatively, innovators may post their submissions in an open manner (e.g., in an open bin in the stock market module). These submissions will then be available for viewing by other innovators. Before an innovator may submit and idea, they must review and rate ideas already in the bin (e.g., at least 10 or 20). Those ideas for rating can, for example, be selected randomly. In this way, the better ideas will, over numerous ratings, be identified.

Additionally, the ideas can be valued through the purchase of interests in ideas. Innovators (and if desired, other individuals or entities) can purchase interests in posted ideas they select, e.g., ideas which they believe will sell well. For example, an idea stock can be divided into 100 increments. The idea originator can retain a fraction of those increments (e.g., 50) and the other increments can be sold in the market. The price for those increments in the particular idea is determined by the market. The purchases are, in effect, betting that the idea will be bought by the company and will sell well once commercialized.

The companies can then purchase whichever ideas they wish (on agreed terms), with the purchase price for the idea split appropriately between the originator and increment investors.

The present system can further assist this process if the system retains a percentage of investor sales, idea sales to companies, and/or royalties on use of ideas. At least some of those monies can be used to assist in commercialization costs for ideas, thus benefiting and/or reducing risk for purchasing companies.

Stock Market of Innovators

Creating a stock market of innovators or teams of innovators can be structured as part of the present system, and can also increase efficiency of the innovative process. Each person or team will be registered and followed not only with their Nerve Score and resume but with a stock value. Every innovator entity (innovator or team of innovators) will be similar to a company on the stock market. They can choose to sell a portion of their future winnings and contracts (collectively “system earnings”) to the highest bidder. For example Joe Smith, after increasing his Nerve Score and building his resume could opt to sell 10% of his future innovation winnings and contracts for five hundred dollars. After winning a few more contests he may choose to sell off the next 10% and now gets 2000 dollars for that 10%. This gives innovators some early money and also incentivizes them to keep competing vigorously to increase their stock value. This is a similar process to athletes with agents. The N-P intuitive perceiver temperament who is a knowledge worker thoroughly enjoys the freedom to use his mind in any way he or she so chooses on tasks that are of interest to them.

This market may also be structured with more varied options. For example, rather than selling a permanent interest in future system earnings, the innovator may sell an interest in earnings for a specified term, or for a specified number of contests or contracts, or for a particular contest or contract, or for set of contests having approximately a specified value. Other variations can also be utilized. Generally, the value of such interests will be based on the past performance and/or perceived future potential of ideas submitted by the particular innovator.

### V. Learning

It is beneficial to take advantage of accumulated knowledge in the present system. Using accumulated knowledge in this way can further facilitate the speed and quality of innovation.

Thus, the present system can include a learning or teaching component, e.g., as an information repository and/or teaching environment. For example, participants may provide podcasts, videos, lectures, papers, and the like on the site or linked the site from another web site. Such materials may be categorized and/or searchable to assist participants in locating useful materials.

An important part of this learning component is the evaluation and rating of the materials made available. Thus, innovators utilizing a particular piece of learning material will rate the material. Based on multiple evaluations (preferably a large number) of the various pieces of learning material, the best quality materials will be identified. This process can also identify the individuals presenting the best materials. Compensation can be awarded for high quality materials and/or to the individuals determined to have presented the best materials e.g., as prizes and/or other compensation. In this way, additional motivation to submit high quality materials can be developed and rewarded.

This process and reward avenue provides another mechanism for innovators in the system to benefit, both through learning, and also potentially through monetary rewards for quality contributions. Thus, in effect, this component of the present system can function as a type of learning institution with a self-refining quality measure.

### VI. Monetization

The present system can advantageously be arranged as a business. Operation of such business involves a process, and that process includes revenue generation, which can form part of the present system and methods. Examples of such revenue sources include, for example, one or more of the following:
1. A percentage, e.g., 1, 2, 3, 45, or greater percentage of the prize for every contest (e.g., awarded prizes or posted prizes);
2. A percentage of every outsourced contract;
3. A headhunters fee for hires of registered innovators, e.g., a fee such as Monster.com garners;
4. Advertisements on the system web site;
5. When the system (e.g., Big Nerve) is working efficiently every company would need to use us or be left behind by their competitor. The system could charge a fee for use.
6. The system (e.g., Big Nerve) can also generate income from a stock market of ideas and/or innovators, and from ideas sold to companies.
7. Big Nerve would eventually be a true incubator for companies. It would be the nexus for capital and innovative ideas. Big Nerve could position itself to take a percentage of each company spun off without venture capital risk.
8. Banking—funds held (e.g., from fees above) will generate interest income.

Exemplary System

The structure and operation of an exemplary system, named BigNerve, can be illustrated by reference to the drawings, which represent pages in a system web site.

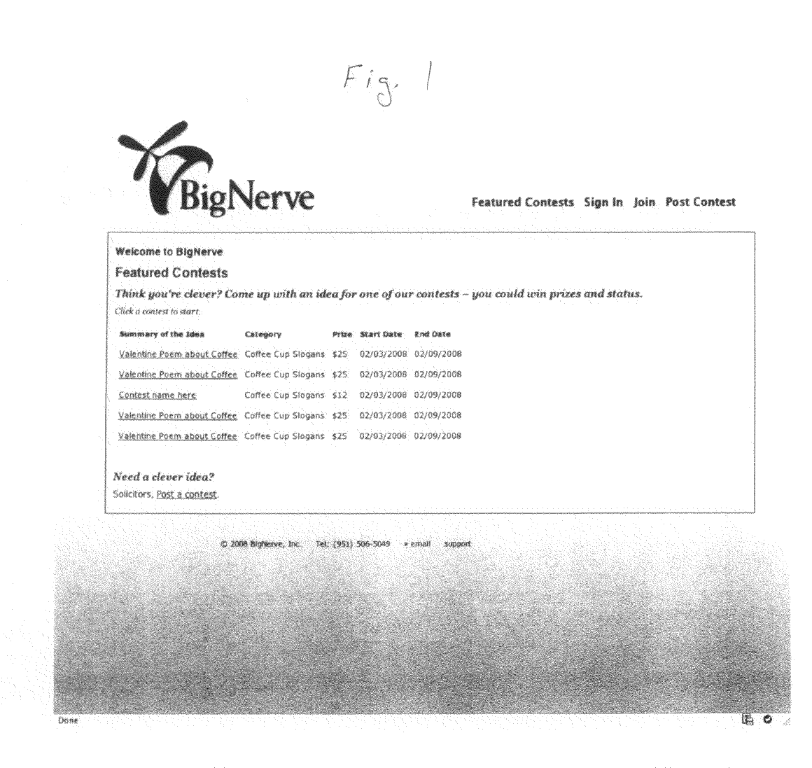

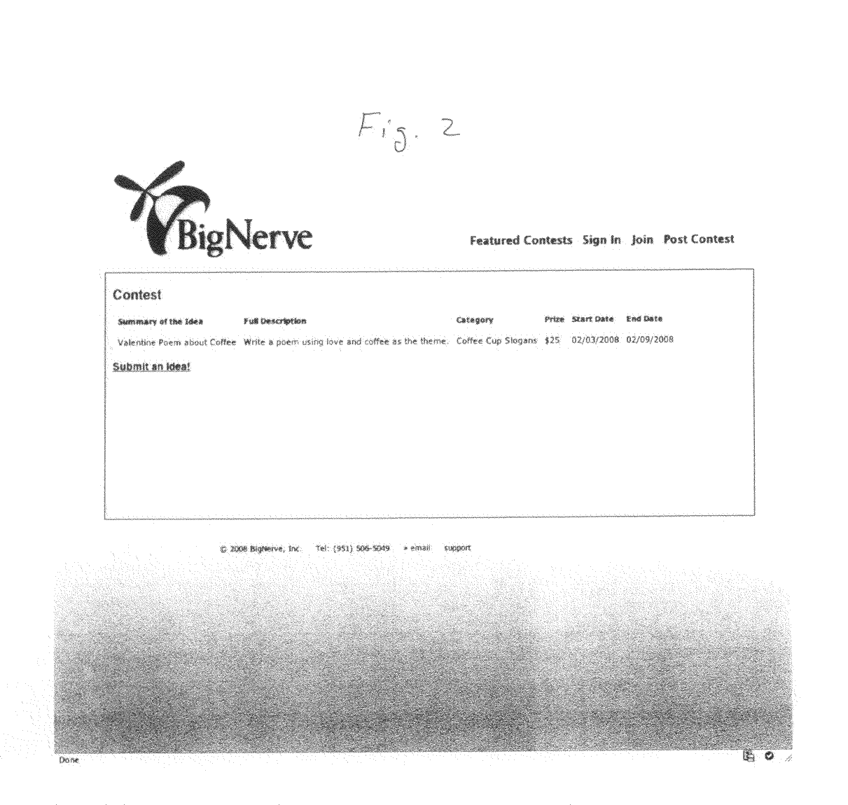

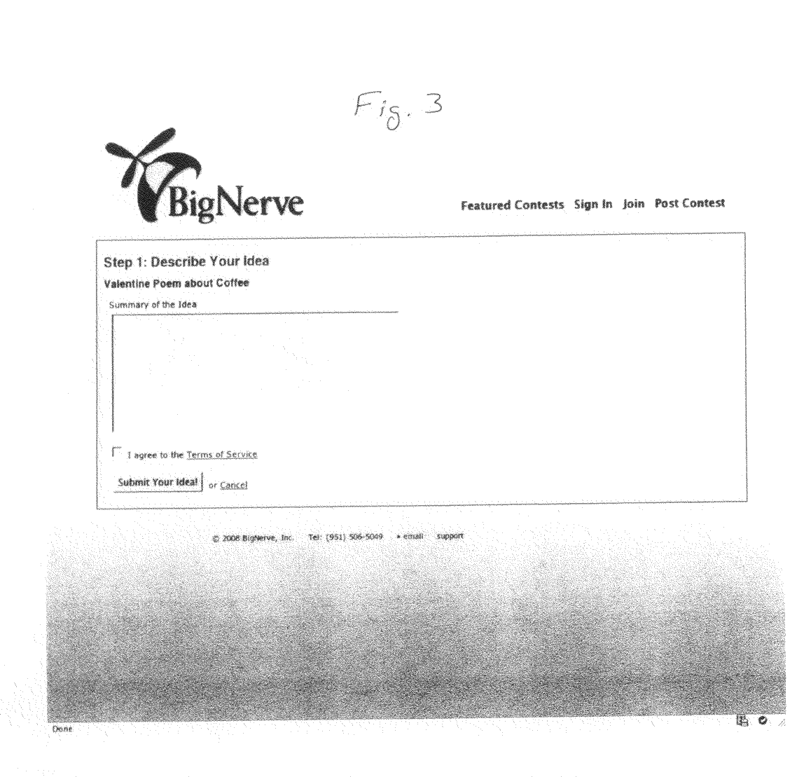

FIG. 1 shows an example of a public page with a listing 2 of available innovation contests presented to innovators. The page also includes a link 4, for solicitors (e.g., companies) to post new contests. Each contest listing includes a link to the contest idea summary, as well as specifying the contest category, prize amount, and the start and end dates for the contest. Selecting one of the contests listed in FIG. 1 links to a particular contest summary screen shown in FIG. 2. In this illustration, the basic information about the selected contest is shown as in FIG. 1, but a more extended description can also be provided. Also provided is a button 8 to access an idea entry page as shown in FIG. 3. An idea entry space 10 is provided, along with an active button 12 to submit the idea after entry. Such a page could also include a project save feature, allowing an in-progress submission to be saved on the system. A cancel feature 14 is also provided, allowing a potential innovator to cancel the draft submission without submitting and without saving.

As indicated, the screen shown in FIG. 1 can be public. In most cases, if a person clicks the button to access the idea entry screen, they will be prompted or sent to a page to register. As an alternative, the registration may take place after submission. The system can also be configured to also accept submissions without registration, e.g., with only contact information, although this is less desirable. Similarly a potential solicitor will usually be prompted to log in, either before or after contest submission, although usually an idea will not actually post until sign in or registration has occurred.

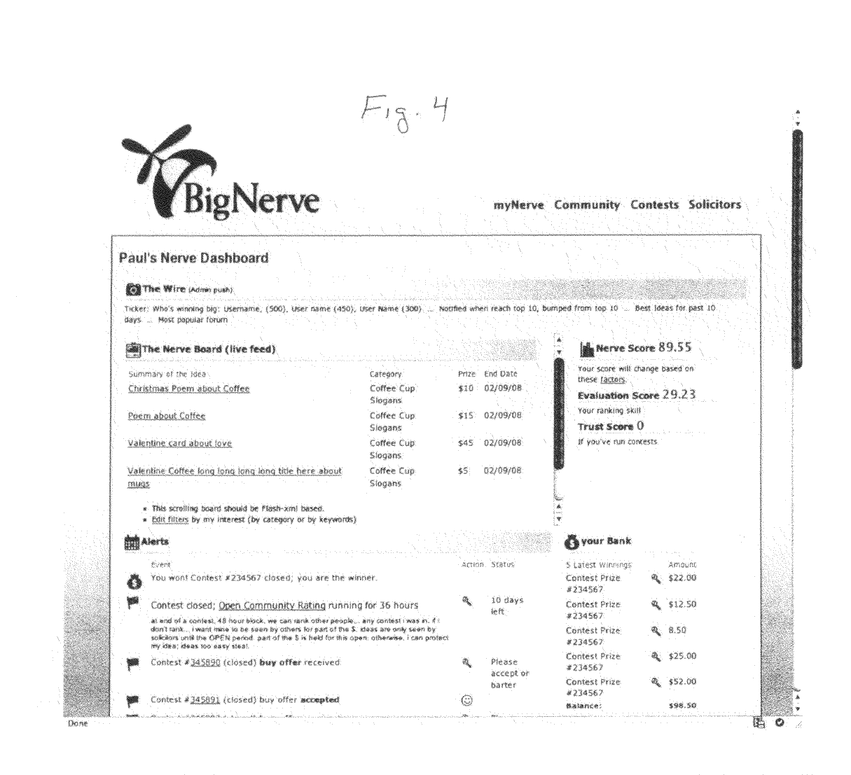

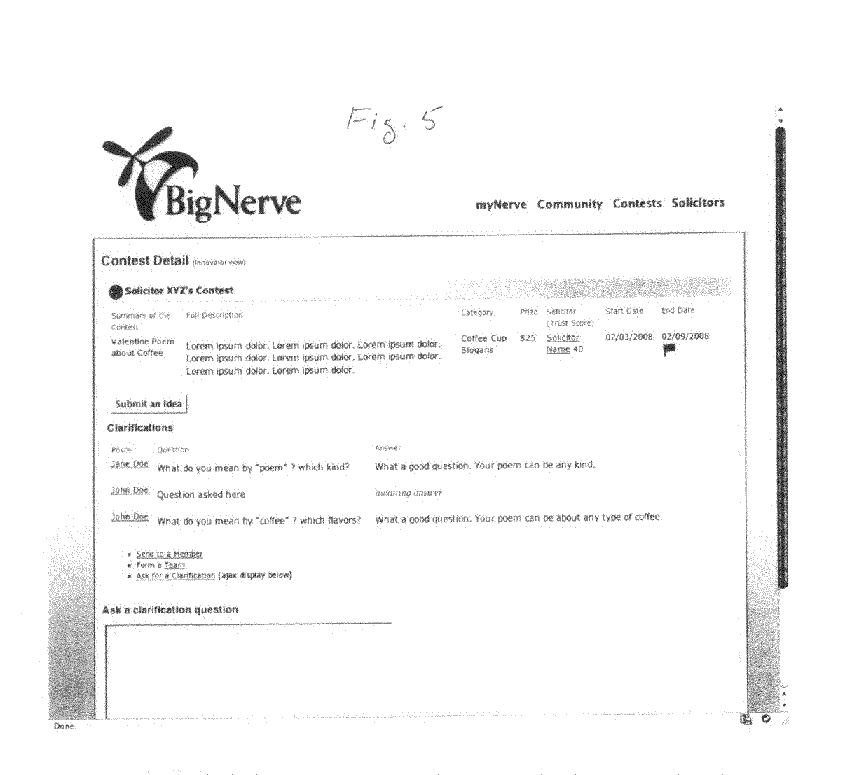

In contrast to a public page, a personal page for a registered innovator is shown in FIG. 4. Such a page can include any of a variety of information, and which can be selected for inclusion by the individual. In this illustration, a list of active contest is provided as “The Nerve Board” 20, along with a listing 22 of the status of contests in which that individual has submitted entries. Also shown is the individuals current Nerve Score (innovator score) 24, evaluation score 26 (representing the innovator's skill in rating other individuals' entries), and Trust Score 28, representing the person's trust level as a solicitor. The page also includes a “Your Bank” section listing prizes won. Registered innovators can also access a contest detail page, e.g., as shown in FIG. 5, e.g., through the contest menu button 30 shown, for example, in FIG. 4. The contest detail page illustrated in FIG. 5 includes additional information concerning the contest in contest block 32, has space for idea entry and submission in box 34, has a box 36 for viewing questions and answers concerning the contest, and further includes a box 38 for entering clarification questions relating to the particular contest.

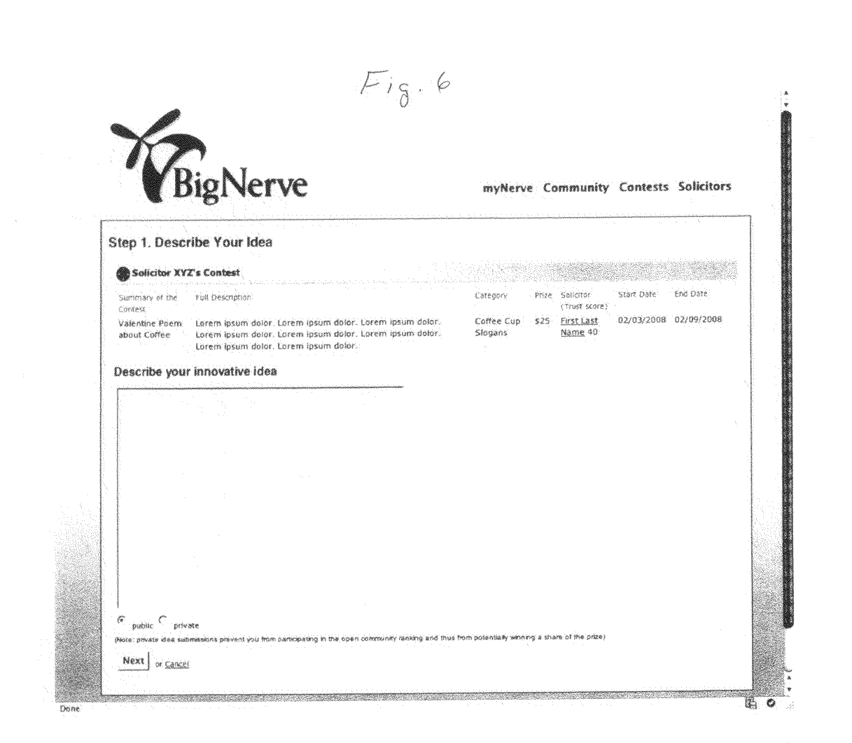

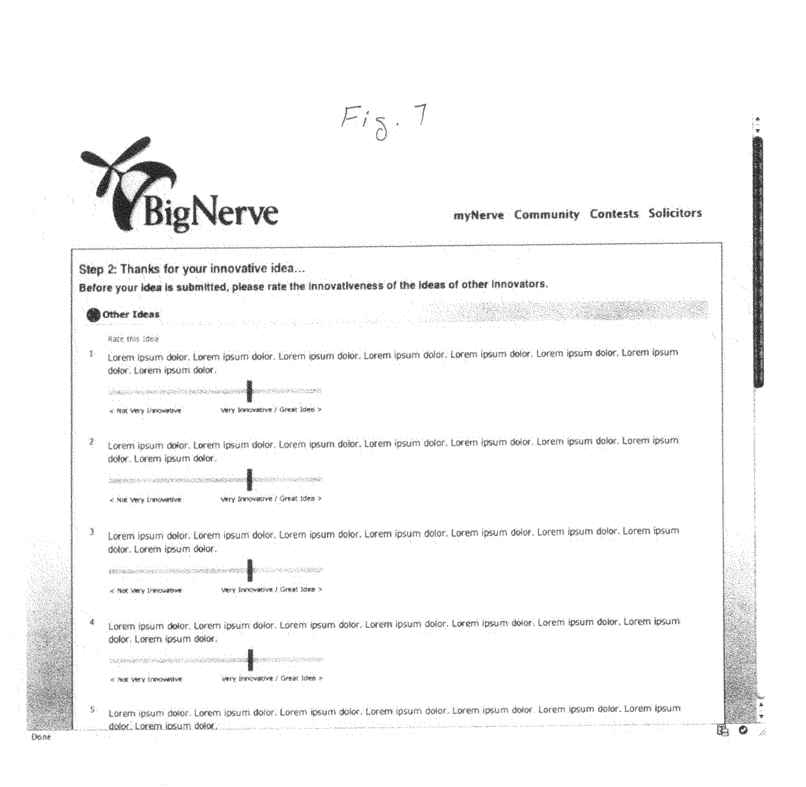

Clicking the “Submit and Idea” button 40 in the screen of FIG. 5 can open an idea submission screen, e.g., as illustrated in FIG. 6, which shows an alternate idea submission screen to that shown in FIG. 3. In the FIG. 6 screen, an innovator sees the summary 42 of the selected contest, including a full description 44 and the solicitor trust score 46 (as in FIG. 5). The screen, of course, includes an idea entry box 48. After entry of the idea and before submission, the innovator can choose whether to make the submission as a “public” or “private” submission using toggle bubbles 50 and 51. Selection of the private option results in the idea submission being viewable by the solicitor for the contest but not by the community of innovators, and therefore will not receive community ratings. On the other hand, selection of the public option means that the submission will be viewable by the solicitor and also by the innovator community, or at least by innovators who submit entries for the particular contest. The screen of FIG. 6 works in conjunction with the screen of FIG. 7.

FIG. 7 presents a set of idea submissions 52 from other innovators for evaluation, i.e., rating. Evaluation may be requested but not required, or may be required before the particular innovator's idea submission will be completed.

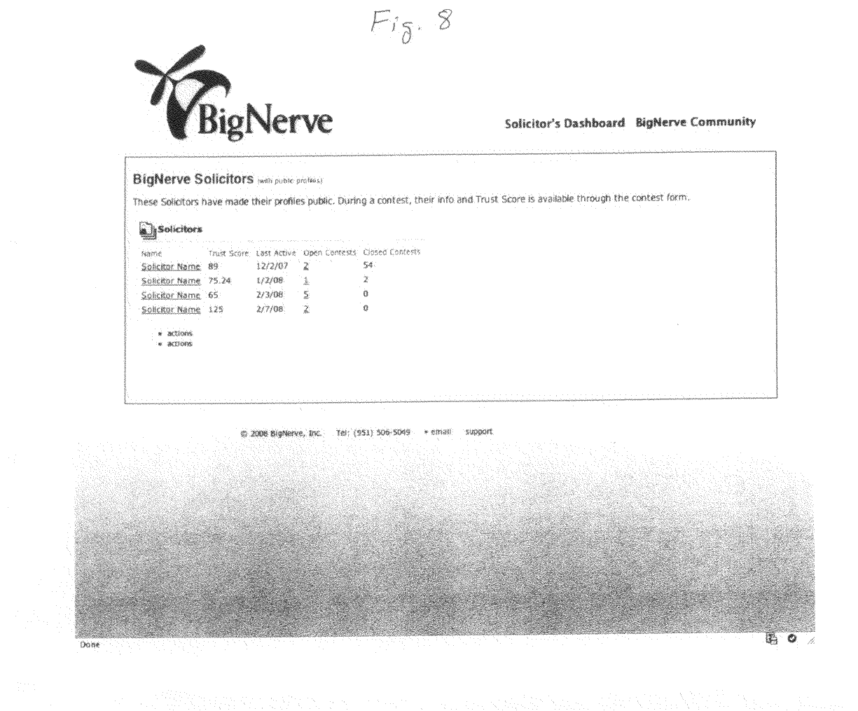

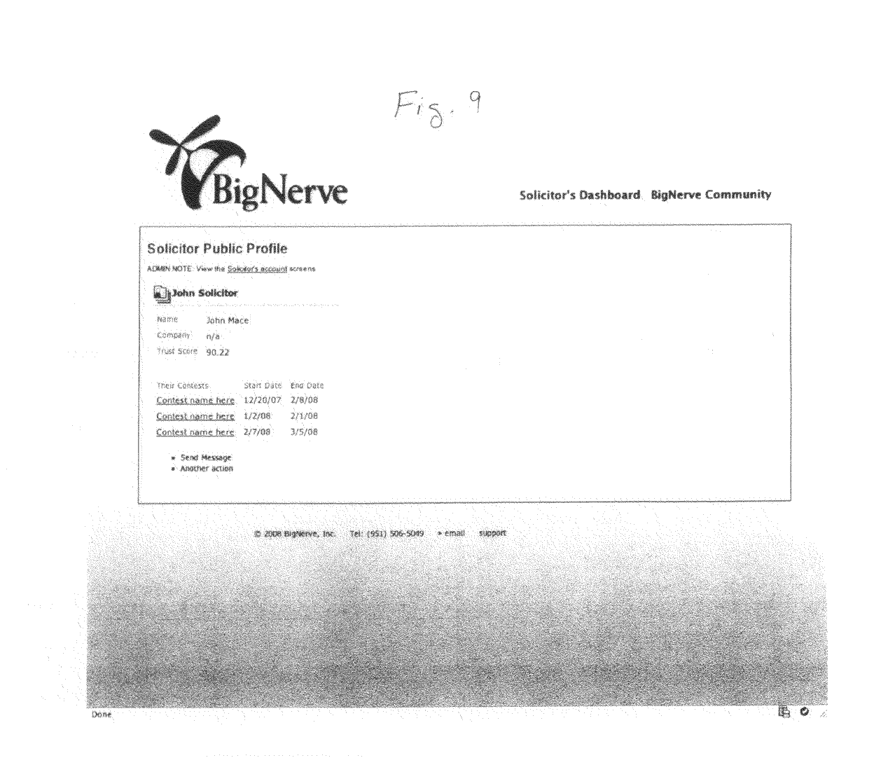

The illustrative screens shown in FIG. 8 and FIG. 9 provide examples of pages providing information concerning solicitors to innovators. The FIG. 8 screen shows a list 54 of solicitors who have made their profiles public, i.e., viewable by innovators. Clicking on a solicitor name opens the public solicitor profile, e.g., as illustrated in FIG. 9.

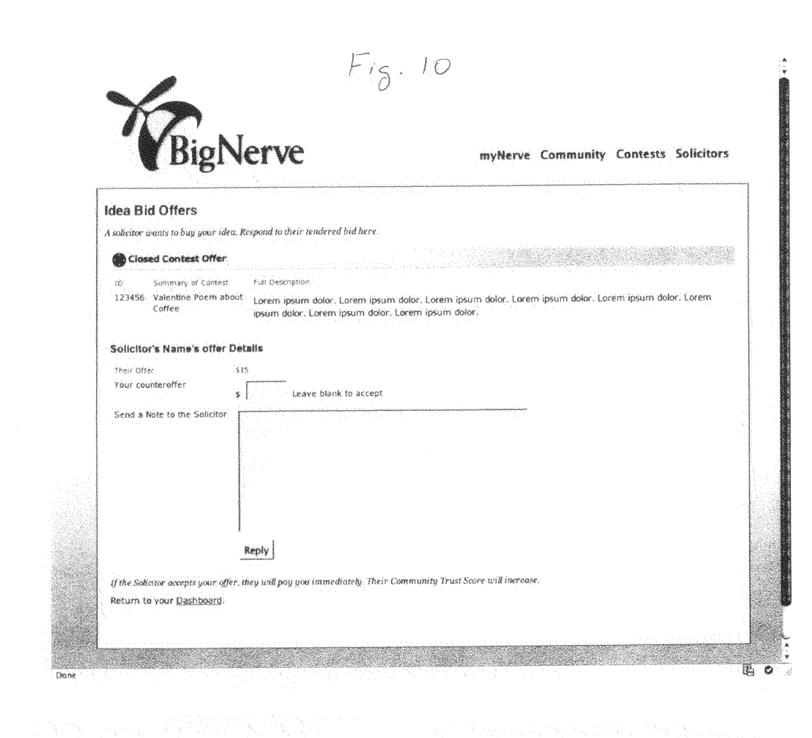

As described above, solicitors can have the option of offering to buy submitted ideas from innovators, e.g., as illustrated in FIG. 10. If a solicitor chooses to make an offer, a screen such as FIG. 10 can be presented to the innovator who submitted the particular idea, containing an offer 56. The innovator has the option of accepting the offer or of submitting a counteroffer 58 and/or sending a note to the solicitor using box 60.

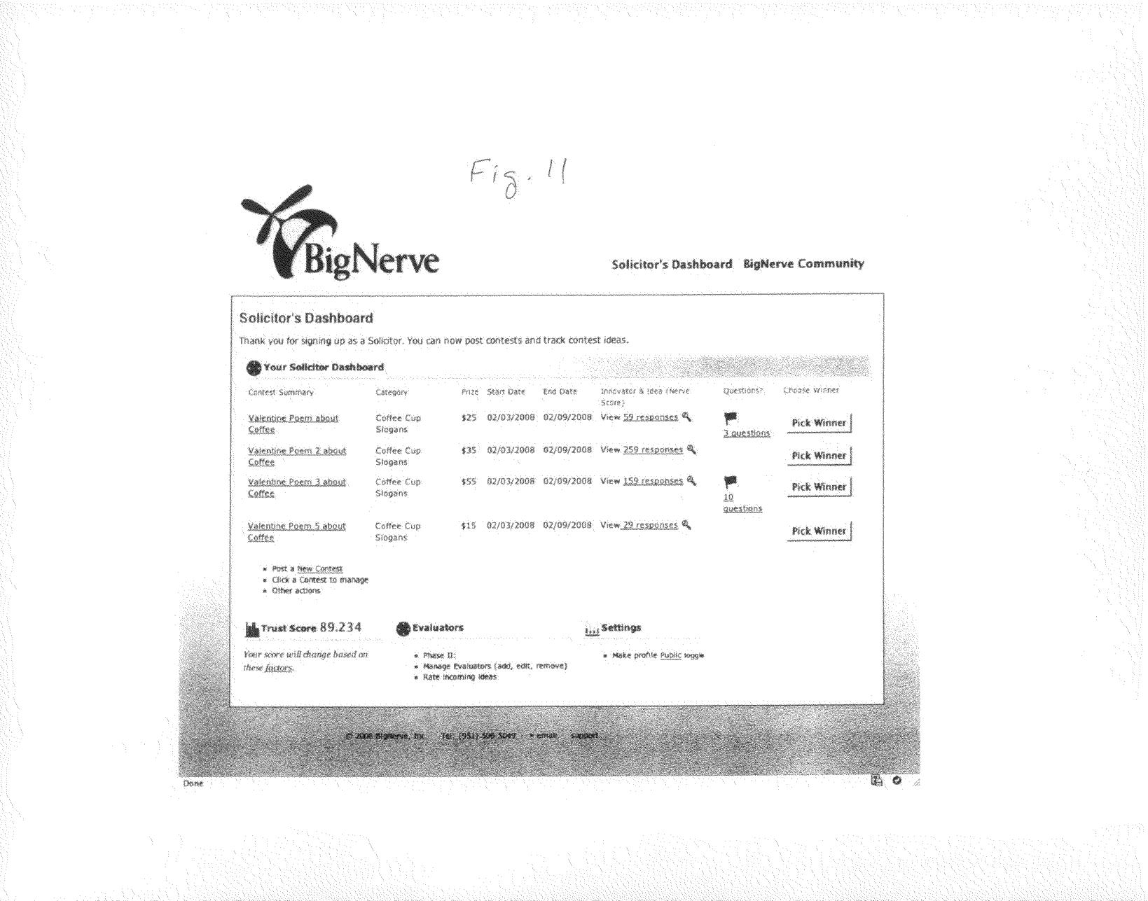

Turning to the solicitor side, FIG. 11 illustrates a dashboard for a registered solicitor, listing that solicitors contests 62 and providing links to additional pages for viewing responses 64, viewing and/or answering questions 66, and picking winners 68, as well as providing additional mechanisms for managing the account and viewing information, including a link 70 for submitting a new contest.

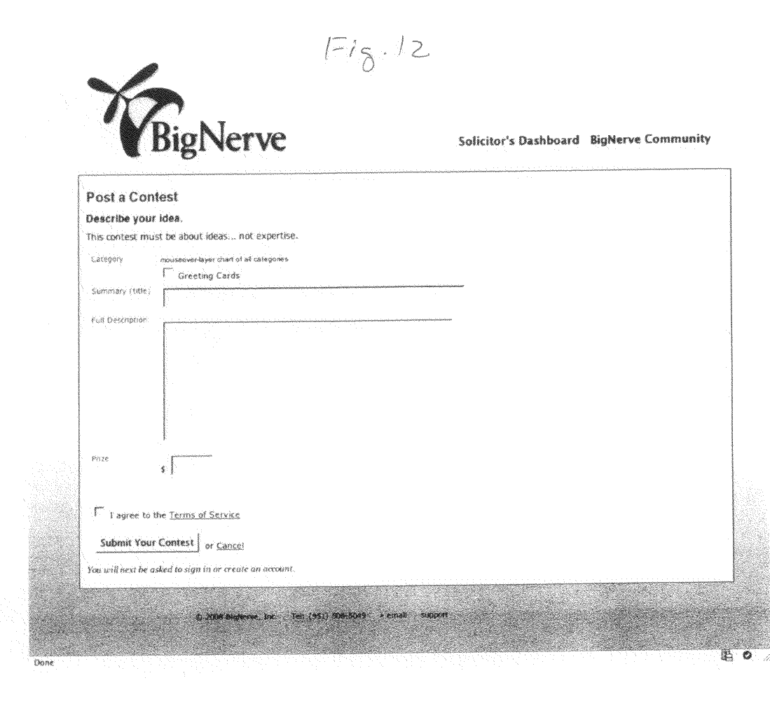

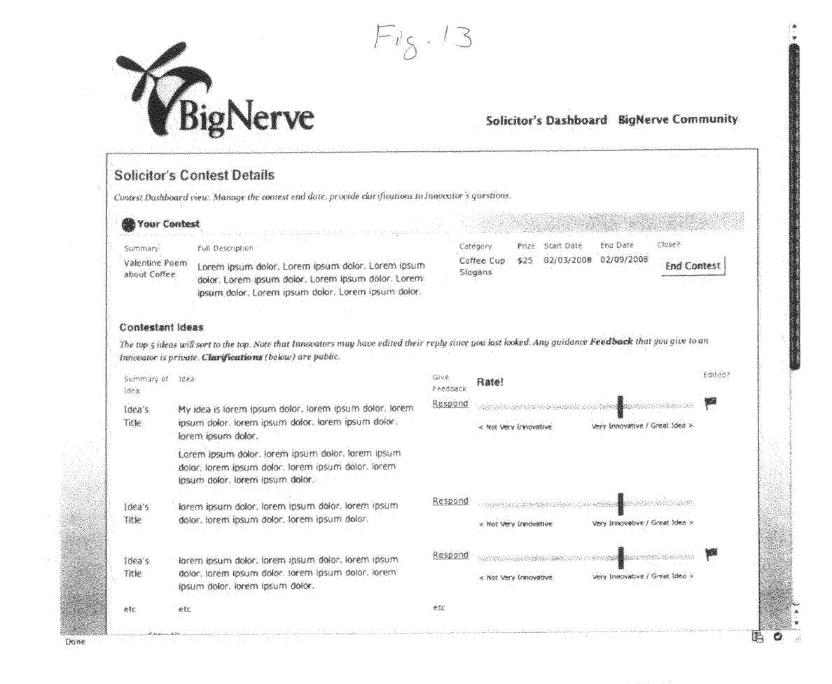

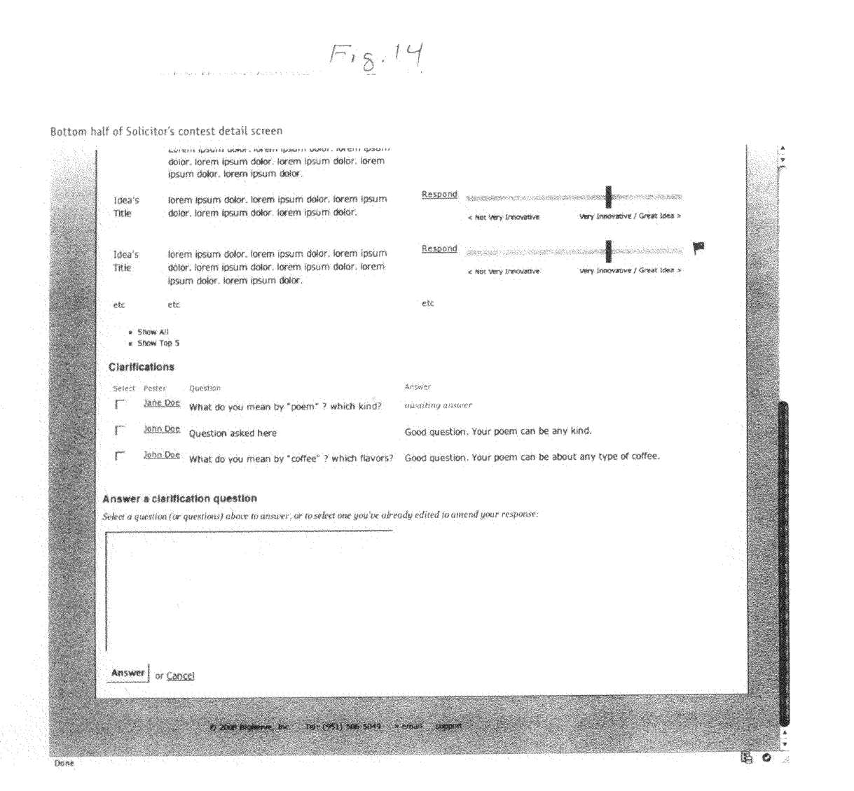

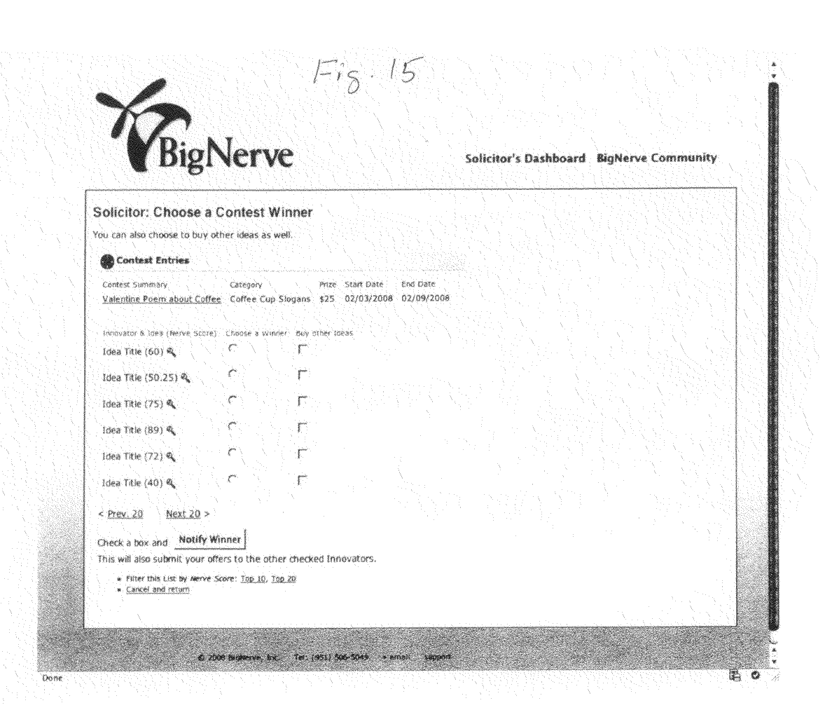

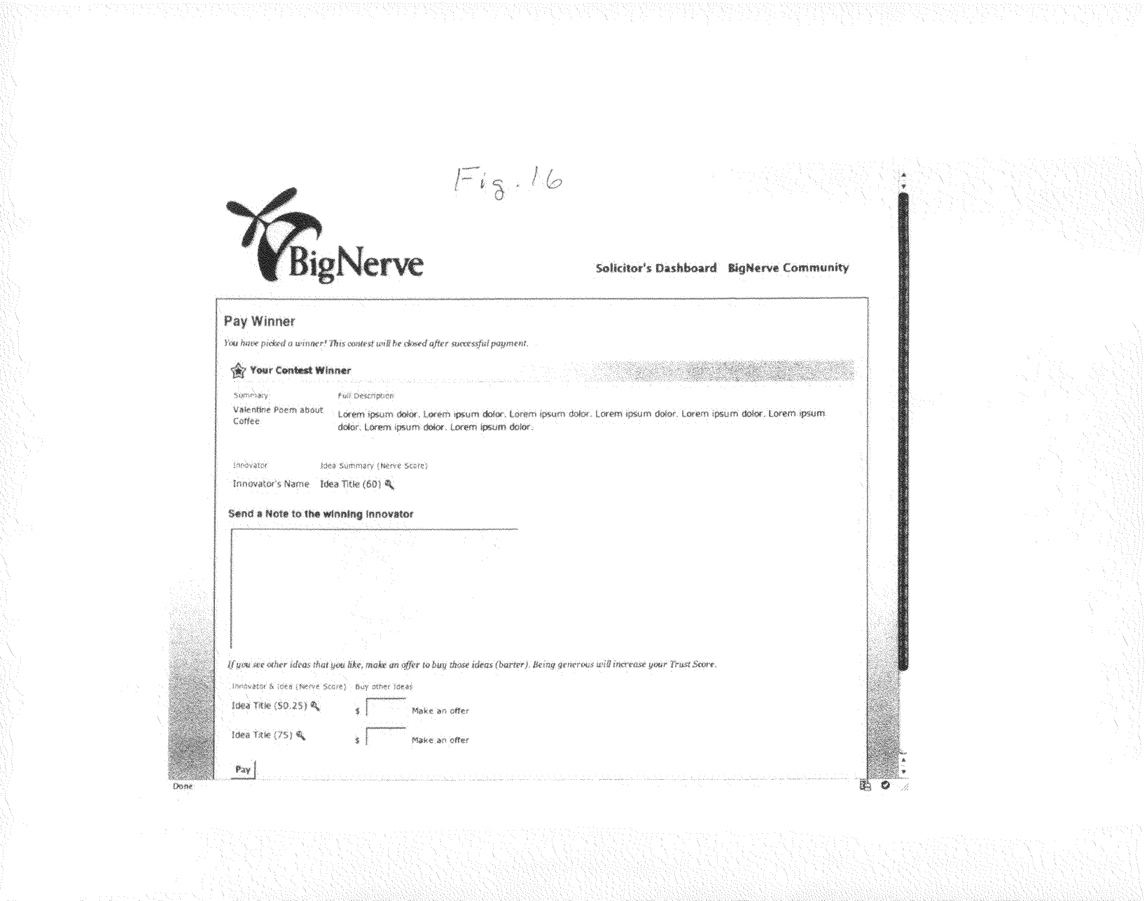

Clicking on a new contest link such as link 70 in FIG. 11 can bring up a contest submission screen such as that illustrated in FIG. 12, which allows the solicitor to enter the relevant information concerning the new contest and then submit the contest. Clicking on a view responses link as in FIG. 11 can bring up a contest details screen such as that illustrated in FIG. 13 and FIG. 14. In this illustration, the contest is identified 72, and the responsive ideas 74 submitted are listed. From this screen, the solicitor can close the contest using button 76, rate the respective entries, e.g., using slide 78 or give feedback to the submitting innovator using link 80. In this illustration, the solicitor can additionally respond to requests for clarification 82 using box 84. Clicking on the Select Winner button of the screen in FIG. 11 can bring up a screen such as that shown in FIG. 15. This illustrative screen allows the solicitor to both select a winner for each of that solicitors contests, as well as to submit offers to buy additional ideas, in this case by clicking the corresponding box 86 or bubble 88. Such identification and offers can be completed in this illustration using a screen such as that shown in FIG. 16 which allows the solicitor to send a note to the winning innovator 90 or to make an offer for one or more additional ideas 92.

The illustrative views shown in the figures are intended to be only illustrative of some of the important views presented in the posting of contests, submission of ideas, evaluation of ideas, selection of winners, and submission of additional idea purchase offers and responses to same, and should not be regarded as limiting the invention. It will be readily recognized that the organization of the various pages and the information and actions available on the various pages can be varied in many different ways.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the types of innovation involved, the nature and prizes for contests, and the parameters used for rating ideas, innovators, and solicitors. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Thus, additional embodiments are within the scope of the invention and within the following claims.

1. A method for fostering innovation, comprising
conducting a plurality of web-based solution contests through a web site on a plurality of problems presented by solicitors, wherein a plurality of innovators submit proposed solutions to said problems;
in each said contest, rating said innovators based on a innovativeness, thereby creating cumulative innovation scores for said innovators; and
in each said contest, selecting a winner who receives a winner's prize or selecting a plurality of innovators submitting proposed solutions not accepted by the solicitor for the respective contest, wherein each of said plurality of innovators receives an incentive reward or receives the opportunity to participate in further development of proposed solutions or both.

2. The method of claim 1, wherein a plurality of said contests are pre-specified time contests.

3. The method of claim 1, wherein a plurality of said contests are open-ended time contests.

4. The method of claim 1, wherein said plurality of innovators comprises at least 100 innovators.

5. The method of claim 1, wherein said innovators register on said web site with identifying information and temperament information.

6. The method of claim 5, wherein said innovators register on said web site with field of expertise information.

7. The method of claim 1, wherein said innovators are registered on said web site and said innovation score is part of a resume for each registered innovator following participation in at least one said contest.

8. The method of claim 1, wherein a plurality of said innovators are selected who participate in a second round of innovation on said problem in a collective collaboration.

9. The method of claim 1, further comprising determining a temperament for a plurality of innovators.

10. The method of claim 9, wherein said innovators are registered on said web site and determining a temperament is performed for each registered innovator.

11. The method of claim 9, wherein intuitive perceiver (N-P) individuals are identified.

12. The method of claim 11, wherein N-P individuals are selected for presentation of at least some of said problems.

13. The method of claim 1, wherein solicitors pay a fee for presenting a problem on said web site.

14. A system for fostering innovation, comprising
a computer accessible web-based system comprising
an innovation contest presentation portion;
a solution receipt portion;
an innovator ranking portion; and
an innovation contest reward portion.

15. A method for identifying a pool of innovator entities, comprising
conducting a plurality of contests on a web-based system presenting a plurality of problems to a plurality of registered potential innovators; and
rating said plurality of innovator entities based on innovativeness and optionally additional parameters, thereby providing an innovation score for said innovator entities.

16. The method of claim 15, wherein a cut-off of cumulative innovation scores is used to create a pool of high performing innovators.

17. The method of claim 15, wherein said innovation scores included weighted scores for cooperation.

18. The method of claim 15, wherein innovators with N-P temperament are separately identified.

19-25. (canceled)
